(19) United States
(12) Patent Application Publication
(10) Pub. No.: US 2011/0208840 A1
(43) Pub. Date: Aug. 25, 2011

(54) Cookie alert

(76) Inventor: Lee Blackman, New York, NY (US)

(21) Appl. No.: 12/660,131

(22) Filed: Feb. 22, 2010

(51) Int. Cl. G06F 15/177; G06F 3/01

(52) U.S. Cl. 709/220; 715/760

(57) ABSTRACT

A portable compatible browser with cookie alert and, allowing a user to take the browser display settings to another PC, or PC to PC without altering the browser settings setup from the first PC when moving to a second PC. And gives the user the capability to set the amount of cookies that can tag or logon to the user browser. Cookies that are logon or tag on to the user browser, automatically displaying on the user monitor or screen in or on a dropdown box, tag, cookie jar and or container giving the user the option to eat or burp the cookie that is display.

### CROSS REFERENCE TO RELATED APPLICATIONS

U.S. patent documents

U.S. patent No.: NONE

### STATEMENT REGARDING FEDERALLY SPONSORED RESEARCH OR DEVELOPMENT

This invention is not associated with any federally sponsored research or development.

### BACKGROUND OF THE INVENTION

1. Field of the Invention

Present invention relates to a portable browser with a cookie alert that alerts an online user while display the number of cookies that are logon or tags the online user browser. More particularly, the invention relates to a customized browser that is used online and offline with an automatic cookie display alert that pops up displaying the total amount of cookies that are in the user cookie jar and display on a user PC automatically and constantly when a cookie is logon or tags an online user browser. The browser is also customized to be a portable customize browser.

2. Description of the Related Art

Present invention relates to a web browser. Browsing the Internet or surfing the web as an online user or subscriber, most PC owners and online user are not aware of the danger of their privacy while surfing the web and how easy it is for someone to steal their private data that is residing on there PC. Most web surfers or Internet users computer (PC) are been invaded and highjack by unknown PC/computer predators or hackers while an online user is using their computer. There are some fraudulent plug ins that are targeted to online users who does not aware of the danger of these plug in. some of the plug ins are programmed to settle themselves in the system folders making it very difficult to delete by most computer user and virus scanned. Some of these malicious programs appears as advertisement embedding themselves on a user PC and show up when a user try to login to an online account they block the user from accessing their account and ask them to reenter their user name and password or states that the user name and password is incorrect while collecting or copying the user login name and password and to make shore they get the correct username and password, they ask the user to reenter the correct password in order to see if the user would enter the same data twice to determining that the user entered the correct username and password by entering the same data twice. When a user logon they turns off the user firewall and or anti virus scan in order to send the data that been copied by the malicious program back to the malicious program provider. Some of these malicious programs also embedded themselves as cookies to follow an online user or web surfer to websites that contain financial information of a user, when the user logon to such account. The user firewall would automatically turns off and the user would be automatically be disconnected from the financial website the user just logon to with a username and password. Some malicious programs are setup to target cookies on a user computer and remain inactive until a user enter some type of data related to what the cookies are set to target unlike a spy. Some programs are set to erase an online user favorites or bookmarks even when the user is not online. While private browsing eliminate a browser history when windows and or tabs are closed to ensuring the suffer privacy for the next time the surfer opens his browser. Private browsing does not eliminate a web surfer browser history when a user or subscriber leaves the first visited website to go to a second or third website ect., so long as the user browser is open. A user accessing an e.mail account is very venerable for such an attack, because email users do not have any easy way of knowing if someone has logon or read their email neither knowing or seeing the time, date, PC user name, type of browser and IP address a user used to login to their email while those data are made available to the providers of the email or email system provider.

### BRIEF SUMMARY OF THE INVENTION

It is an object of the present invention to provide a portable compatible customize browser that allow a user or subscriber to take the user computer browser display settings and or web browser settings to anywhere the user chose to go, from one PC to another or PC to PC without any of the browser settings been altered or lost from the way in which it has been setup on the first PC or before moving from the originated PC the browser settings had been setup on. A user would plug in the portable customize browser or portable compatible customize browser into a second PC that would automatically run the browser application software and interface then display it on the second PC the same way in which it had been setup or architecture on the first PC. The browser setting is displayed the same way as if the user was using his regular computer or PC. The portable customize browser settings is architecture with an automatic save button or device to allowed a user to automatically save bookmarks and or favorites in a portable URL registry (portable website URL library/PLibrary) means that an online user or subscriber is able to save their bookmarks and or favorites in a pre customized bookmarks and or favorites folder and or file that is pre configured with a software program to make the said folder and or file portable favorites and or bookmark folder and or file on a portable automatic URL saving device for the user to take the save bookmarks or favorites anywhere from one PC to anther or PC to PC making the user bookmarks and favorites, portable bookmarks and favorites on a portable URL registry or portable website URL library (ULibrary/PLibrary). The bookmark and or favorites are stored on a portable digital device or portable digital bookmarks device, portable digital favorites device or portable URL registry (portable website URL library) or portable digital web library device. A user access the portable URL registry (portable website URL library) save bookmarks and or favorites by plugging the device into or attaching it to a PC. Another method of the invention is to provide an automatic cookie display alert that would display the amount of cookies that are tagged or logon onto an online user web browser. The method control the amount or number of cookies that can follow or tag a user browser at onetime or that can remain in the user cookie folder while the user moves or go to various different websites or surfing the web.

(More particularly, the invention relates to a method for a user to allowed or disallow websites that the user been to or visited in the past or while online from targeting or following the user browser next or future website visit by automatically deleting the previous visited website cookies in the web surfer cookie folder or cookie container and or a dropdown box, tag and cookie jar). The portable customize browser is a portable customize browser application software with an automatic cookie display alert that allowed a user or subscriber to controlled the amount of cookies that can tag or logon to the user or subscriber browser at a time. The user subscriber has the capability to set the amount of cookies that can tag or logon to the user browser at the same time. The user subscriber can also see the number of cookies that are logon or tag an online user browser automatically displaying to the user on the user screen in/on a dropdown box, tag, cookie jar and or container with the total number of cookies displaying in a/the cookie jar, box, on a tag and or in a container. The customize portable browser application software constantly automatically displaying a cookie alert to a user or subscriber when a cookie logon or tag an online user browser giving the user or subscriber of a PC or internet browsing device an option or allowing the user to eat the cookie or to burp out or burp the cookie from the user cookie tag, jar, container and or a dropdown box or display alert while the user is surfing the web or after surfing the web. All of the talk about and or described pre customized software program and their plug ins are distributed by download and or on a portable device.

Another objective of the invention, relates to a method for a user to allowed or disallow websites that the user been to or visited in the past or while online from targeting or following the user browser next or future website visit by automatically deleting the previous visited website cookies in the web surfer cookie folder or cookie container and or a dropdown box, tag and cookie jar, before going to or visiting a new website.

Another method for the invention is to provide or add an application software or plug in with a second web history folder and or database that would reside and or added to a user document (my document) folder. By adding a second or new web history folder or database that reside in a user my document folder makes it none accessible to an outsider user other than the pc user. None accessible to user means unable to be read by another person or website (third party) when the user moves between different web pages and or from web site to website while automatically deleting the original or first history folder data. The pc user/surfer gets back to previous web pages or websites using a toolbar. A third party or website would need authorization to remotely access a user pc, means that the second or new web history folder and or database is accessible to the user only.

The foregoing and other objects, features, and advantages of the invention will be visible from the following description of preferred drawings of the invention as illustrated in the accompanying drawings.

### BRIEF DESCRIPTION OF THE DRAWING

FIG. 1 is a diagram showing a portable customized browser display settings.

FIG. 2 is a diagram showing a portable customize browser cookie display.

FIG. 3 is a diagram showing a user e.mail past login history.

FIG. 4 is an illustrated diagram showing a second web history tool bar.

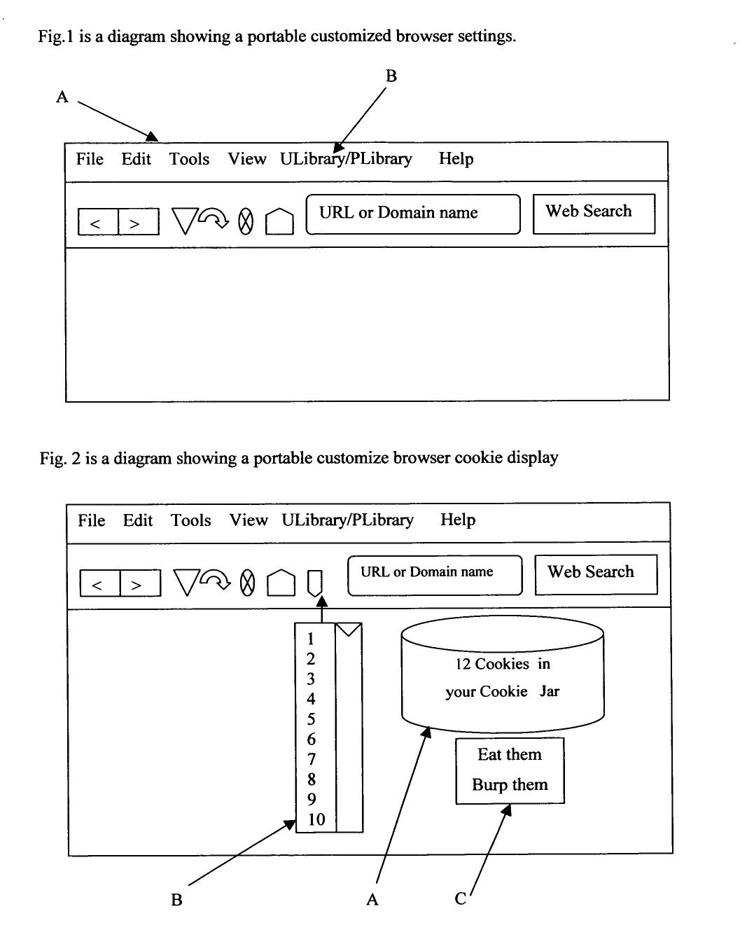

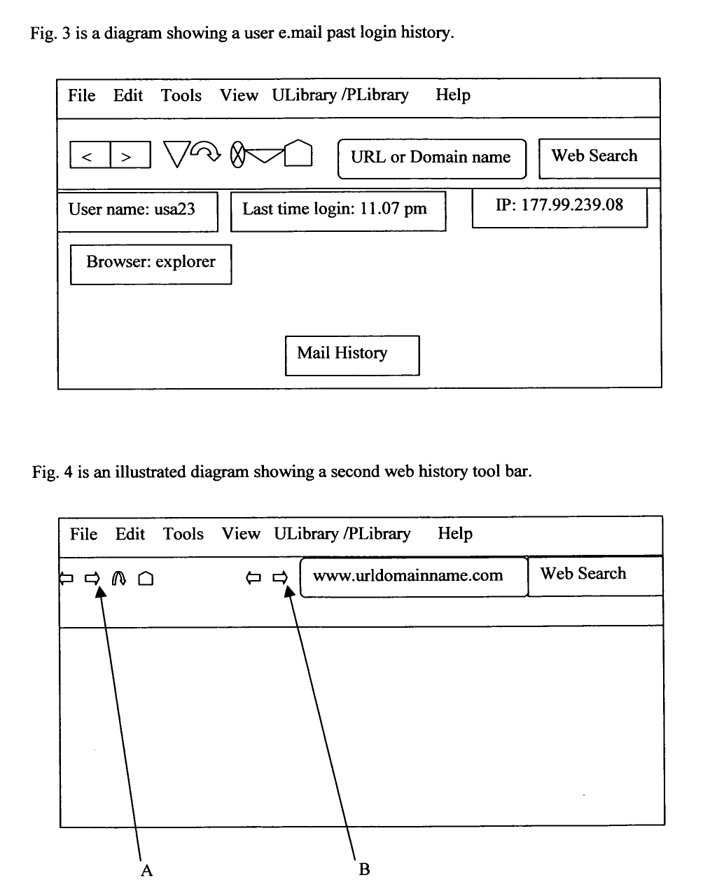

### DETAIL DESCRIPTION OF THE INVENTION

FIG: 1A. Is showing a portable customized browser settings display with the customize browser tools on the browser application software. The portable compatible customize browser can also work as a plug in with any existing browser. The portable compatible customize browser allow a user or subscriber to take the user computer browser display settings and or web browser settings to wherever the user chose to go, from one PC to another PC or from PC to PC without any of the browser settings been altered or lost/altered from the way in which it had been first setup on the first PC or originated PC the browser settings had been setup on. The user would plug in the portable customize browser or portable compatible customize browser into a second PC that would automatically run the browser application software interface and display it on the second PC the same way in which it had been setup or architecture on the first PC. The browser setting is displayed the same way as if the user was using his regular computer or PC. A user or subscriber must first obtain a copy of a portable customize browser settings software program before they can used such features in a browser. B is showing how the plug in URL registry is contain and or displayed portable URL registry or portable website URL library (ULibrary/PLibrary) button or device is embedded into the browser settings. B shows a portable customize browser settings architecture with an automatic save button, device or plug in URL registry or URL library (ULibrary/PLibrary) to allowed a user to automatically save a URL or domain name and its extension or bookmarks and favorites in a portable URL registry (portable website URL library) on a portable automatic URL saving device so the user can take the save URL registry or URL library with its domain name and its extension page name, bookmarks and or favorites anywhere the user goes, from PC to PC making the user URL registry or URL library, bookmarks and favorites a portable URL registry or URL library portable bookmarks and favorites. The URL registry or URL library, bookmarks and favorites are stored on a portable digital device or portable digital URL registry or URL library, portable bookmarks device, portable digital favorites device containing a customize portable URL registry or URL library folder or file application software program. A user or subscriber must first obtain a copy of a portable customize URL registry or URL library folder or file application software program to access such features.

FIG: 2A, Shows the portable customize browser application software with an automatic cookie display alert that allowed a user or subscriber to controlled the amount of cookies that can tag or logon to the user or subscriber browser at a time. It also shows that a cookie logon or tag an online user browser automatically displaying to the user on the user monitor or screen in/on a dropdown box, tag and or container means a cookie jar with the total number of cookies displaying in the said jar, box, on a tag and or container. B is Showing a user subscriber has the capability to set the amount of cookies that can tag or logon to the user browser at the same time. A shows the user subscriber seeing the number of cookies that are logon or tag an online user browser automatically displaying to the user on the user screen in/on a dropdown box, tag, cookie jar and or container with the total number of cookies displaying in the cookie jar, box, on a tag and or container. The customized portable browser application software constantly automatically displaying a cookie alert to a user or subscriber when a cookie logon or tag an online user browser. C is showing a user or subscriber is given the option or allowing the user to eat the cookie or to burp out or burp the cookie from the user cookie tag, jar, container and or a dropdown box or display alert while the user is surfing the web or after surfing the web. A user eats a cookie by allowing the cookie to remain in his cookie jar, on a tag, container and or a dropdown box or display alert folder or burps the cookie by removing the cookie from the cookie jar, tag container and or a dropdown box or display alert.

FIG: 3. Shows an email account and or email system that allows a user to see or view a/the past logins history of an email account user means the time, date, PC user name, type of browser and or IP address used to login to an email account or email system where a user past logins or login history is made available to a user or subscriber and or be available to be access by a user for a limited period of time example 3 days and or none limited period.

FIG. 4(a) is showing an illustrated diagram with the forward and backward arrows tool bar that access a regular (first history) or normal/old history folder. (b) is showing a second or new/added web history tool bar on a browser that a user or surfer will used to get back to previous websites or web pages visited. Both the user or surfer (subscriber) first or normal/regular web history and cookies are automatically been deleted before going on to a new website or after leaving a website.

The present invention has been described with each embodiment. It will be apparent to those skilled in the art would fine various modifications to the embodiment, it is understood that the illustration and example described herein may be combined with other embodiment(s) described herein and has clearly describe the scope and sprit of the invention without limitation.

I claim:

1-16. (canceled)

17. The method for providing an automatic cookie alert, comprising:
a. software wherein the software display a portable browser interface with an automatic cookie display alert;
b. a first PC for displaying the user browser settings wherein the browser settings from the first PC is move to and or display on a second PC;
c. user or subscriber using a browser or plug in wherein the number of cookies that are logon or tag onto the user browser automatically display to the user on the user screen in or on a displayed dropdown box, tag, cookie jar and or container with the total number of cookies;
d. cookie software interface that gives the user subscriber the capability to controlled and or set the amount of cookies that can tag or logon to a user browser at the same time.

18. The method of claim 17, wherein user has the capability to set the amount of cookies that can tag or logon to the user browser.

19. The method of claim 17, wherein the first PC browser settings is taken and or display on a second PC without altering the browser settings any of the settings when the browser is taken to a second PC.

20. The method of claim 17, wherein said second PC display a first PC browser settings without any of the browser settings been altered.

21. The method of claim 17, wherein the user control the amount or number of cookies that can follow a user browser.

22. The method of claim 21, wherein cookies follow a user the user can disallow a previous website been visited in the past or while online from targeting or following the user browser next or future website visit.

23. The method of claim 17, wherein the software with an automatic cookie display alert displaying the number of cookies.

24. The method of claim 23, wherein the number of cookies displayed are in a browser with a cookie alert that alerts an online user while display the number of cookies that are logon or tags the online user browser.

25. The method of claim 17, wherein the second PC display a first PC browser settings without any of the browser settings been altered.

26. The method of claim 17, wherein the cookie alerts a user with an automatic cookie display alert that pops up displaying the total amount of cookies that are in the user cookie jar or container display on the user PC automatically and or constantly when a cookie is logon or tags an online user browser.

27. The method of claim 17, wherein the first PC browser settings has a portable URL registry, cookie alert folder and or file.

28. The method of claim 27, wherein the portable URL registry is a portable customize browser settings architecture with a portable digital web library device.

29. The method of claim 28, wherein the portable customize browser having a cookie alert folder.

30. The method of claim 28, wherein the portable customize browser having a cookie alert file.

30. The method of claim 28, wherein the user access a portable URL registry by plugging the device into or attaching it to a PC.

31. The method of claim 24, wherein the number of cookies displayed are in a portable browser with a cookie alert that alerts an online user while display the number of cookies that are logon or tags the online user browser.

32. The method of claim 30, wherein the user access a portable browser by plugging the device into or attaching it to a PC.

33. The method of claim 21, wherein the user control the amount or number of cookies that tags a user browser.

34. The method of claim 22, wherein cookies follow a user the user can choose to eat the cookie.

35. The method of claim 22, wherein cookies follow a user the user can choose to burp or burp out the cookie from the user cookie jar or dropdown box.

36. The method of claim 17, wherein the cookie display on the browser settings is displayed by the number of cookies.
